(19) United States
(12) Patent Application Publication
(10) Pub. No.: US 2009/0258291 A1
(43) Pub. Date: Oct. 15, 2009

(54) DIRECT MANUFACTURED FUEL CELL PLUG AND METHOD

(75) Inventors: Jim S. Piszar, Chesterfield, MO (US); James A. Witte, O'Fallon, MO (US)

Correspondence Address: NovaTech IP Law, 1001 Ave. Pico, Suite C500, San Clemente, CA, 92673, US

(73) Assignee: THE BOEING COMPANY, Chicago, IL (US)

(21) Appl. No.: 12/103,491

(22) Filed: Apr. 15, 2008

(51) Int. Cl. H01M 2/08

(52) U.S. Cl. 429/185

(57) ABSTRACT

The invention is directed to a direct manufactured fuel cell plug, preferably used with aircraft fuel tanks or bays, comprising a digitally manufactured part, wherein the fuel cell plug is designed to securely fit into and seal an opening to be sealed in a fuel tank to eliminate all substantial gapping between the fuel cell plug and the opening. A sealant material is applied to the fuel cell plug prior to securely fitting and sealing the fuel cell plug into the opening. The invention is further directed to a method for sealing a fuel tank or bay, preferably in an aircraft. The method comprises the steps of applying an adhesive sealant to all faying surfaces of a direct manufactured fuel cell plug, positioning the sealant applied plug into an area to be sealed in the fuel tank, and spraying the entire sealed area with a spray sealant.

### GOVERNMENT LICENSE RIGHTS

This invention was made with United States Government support under Contract Number DAAH10-00-0052, awarded by the United States Navy, Office of Naval Research. The United States Government has certain rights in this invention.

### BACKGROUND OF THE INVENTION

1) Field of the Invention

A direct manufactured fuel cell plug and method for sealing a fuel tank or fuel bay are provided. More particularly, a direct manufactured fuel cell plug and method for sealing a fuel tank or fuel bay in an aircraft are provided.

2) Description of Related Art

Aircraft, boats, and other large movable structures that use fuel to operate typically have fuel tanks or fuel bays with fuel seal boundaries around the fuel tanks or bays to prevent leakage of fuel out of the fuel tanks or bays. In addition, with respect to aircraft, the fuel seal boundaries also support aircraft loads. Integral fuel tanks are areas inside an aircraft structure that have been sealed to allow fuel storage. Most large transport aircraft, such as commercial airplanes and military airplanes or jets, employ integral fuel tanks which store the fuel in the wings and fuselage of the aircraft. To save weight or space, all or some of the fuel tanks required for storing fuel are obtained using the confined volume(s) of one or more hollow structures, for example, those belonging to the wings, in order to contain the stored fuel directly. Since these fuel tanks are part of the aircraft structure, they cannot be removed for service or inspection. Inspection panels must be provided to allow internal inspection, repair, and overall servicing of the tanks.

Known design requirements for certain primary aircraft structures can create a large gap (e.g., approximately 2 inches by 1.5 inches) in the structure at a fuel seal boundary. Known devices and methods for fuel sealing require a ¼ inch maximum gapping to mitigate the possibility of fuel leaks. Thus, gaps which are greater than ¼ inch in size which can form at the fuel seal boundaries of fuel tanks or bays, are often plugged or sealed with known fuel cell plug devices and methods for sealing. However, a difficulty with known devices and methods is that they often require the use of one or more fasteners to secure gap filling pressurized plugs to the nearby structure. The use of such fasteners can be expensive and time-consuming to install. Fastener holes must be drilled in order to install the fasteners, and mating pieces need to be pulled apart with metal burr debris cleaned up and metal chips vacuumed out. In addition, the installation of such fasteners often requires sealant to be applied to all gaps, dry fiberglass cloth to be applied over the sealant, additional sealant to be applied to secure the dry fiberglass cloth, and curing of the sealant. These additional steps result in increased time and expense. Moreover, with known devices and methods, the sizing of the fasteners has to be determined much earlier in the defined process. It is necessary to make sure the fasteners fit the surrounding pieces of the structure, and thus, the overall structure must be planned and designed prior to installation. This increases the time and expense associated with such known devices and methods Moreover, when a fastener is installed into the fuel tank or surrounding structure, a hole is created, and the creation of such a hole may be a place for fatigue or a crack to form. Thus, the structure needs to be heavier to accommodate the existence of the holes that are formed to accommodate the fasteners. In addition, fasteners can add weight to the aircraft or boat structure, if the manufacturability of the fasteners competes with intricate geometries of the parts. The fuel seal plug may have to carry extra weight in order to make it manufacturable. Finally, fasteners used with known devices and methods may become loosened over time and fail to maintain the fuel cell plug or sealing device securely in place.

Another difficulty with known devices and methods for sealing fuel seal boundaries is that known sealing devices, such as dams, are often constructed of metal and may be susceptible to rust or corrosion formation. Such metal sealing devices must be coated with a primer and/or corrosion resistant paint or coating to prevent rust or corrosion formation. For example, a dam made of aluminum typically requires at least a coat of primer and a coat of corrosion resistant paint. The application of a primer and/or an additional paint or coating increases the time and expense of such devices and methods. Moreover, metal devices are often stiff and have limited flexibility when attempting to insert them and make them fit into the fuel seal boundary opening or gap.

Another difficulty with known devices and methods is that they are not direct manufactured and are typically manufactured by machining with a machine tool which further increases the time and expense. For example, if a known fuel cell plug has to be machined into a small and intricate shape from a large piece of stock material, such as an aluminum plate, much of the material is wasted and costs are increased. Because known devices and methods are not direct manufactured, they can require expensive machining processes.

Accordingly, there is a need for a fuel cell plug and method for sealing a fuel tank or fuel bay in an aircraft, boat, or other large movable structure that uses fuel to operate that has advantages over known devices and methods.

### SUMMARY OF THE INVENTION

This need for a fuel cell plug and method for sealing a fuel tank or fuel bay in an aircraft, boat, or other large movable structure that uses fuel to operate, that has advantages over known devices and methods, as well as a unique, nonobvious, and advantageous fuel call plug and method, is satisfied. None of the known devices and methods provides all of the numerous advantages discussed herein. Unlike known devices and methods, the invention provides the following advantages: the invention is a direct manufactured fuel cell plug and method that uses a standard sealant to form a novel fuel seal boundary in moveable structures, such as aircraft and boats; the method of the invention uses a direct manufacturing process by which a three-dimensional CAD (computer aided design) model is computer generated and directly converted to a finished fuel cell plug; the method of the invention allows for sizing or design changes to the fuel cell plug to be quickly and easily made, and intricate details and geometries to promote sealing and assembly can be incorporated in the design with little potential for manufacturing impact; the invention provides a design-liberating, time-saving and machine tool-less fuel cell plug and method for sealing large gaps greater than ¼ inch and closing fuel seal boundaries in fuel tanks or bays of structures, such as aircraft and boats, for eliminating fuel leak paths of such structures, and for holding fuel pressure; the fuel cell plug and method of the invention does not require a fastener or fasteners to hold the fuel cell plug in place due to the intimate relationship between the geometries of the fuel cell plug and the surrounding structural parts; the fuel cell plug and method of the invention can be used with an adhesive sealant material to hold the fuel cell plug in place; the fuel cell plug can be manufactured in a desired shape to maximize the surface area that is in intimate contact with adjoining parts, thus eliminating or decreasing the possibility of leaks or gaps between the fuel cell plug and the adjoining parts; the fuel cell plug and method do not impact the integrity of the nearby aircraft structures; the fuel cell plug and method of the invention simplify aircraft part maintenance by eliminating crack initiating holes and additional loads associated with known devices and methods; the fuel cell plug and method of the invention can be made of plastic or other non-metallic materials and thus provide a fuel cell plug that is flexible and not as stiff as the surrounding structure, so it can be more easily installed into the structure, is not susceptible to rust or corrosion, and does not need to be treated with a primer and/or corrosion resistant paint; the fuel cell plug and method of the invention supports late insertion of technology and is particularly beneficial for low production aircraft; the fuel cell plug and method of the invention reduces touch time for assembly and reduces to one the number of processes necessary to produce the part, whereas as many as six processes may be required for known devices and methods; the fuel cell plug and method of the invention are less expensive and time consuming to manufacture than known devices and methods by reducing costs of the fuel cell plug and adjacent parts, reducing cycle time for manufacturing and installation of the fuel cell plug, reducing overall part count, and reducing overall inventories of parts currently required.

In an embodiment of the invention, there is provided a direct manufactured fuel cell plug comprising a digitally manufactured part, wherein the fuel cell plug is designed to securely fit into and seal an opening to be sealed in a fuel tank to eliminate all substantial gapping between the fuel cell plug and the opening, and further wherein a sealant material is applied to the fuel cell plug prior to securely fitting and sealing the fuel cell plug into the opening.

In another embodiment of the invention, there is provided a system for forming a fuel seal boundary in an aircraft fuel bay comprising: a digitally manufactured part created on a computer as a three-dimensional computer aided design (CAD) model and converted into a physical finished part comprising a direct manufactured fuel cell plug designed to form the fuel seal boundary and eliminate all substantial gapping between the fuel cell plug and the aircraft fuel bay; an adhesive sealant applied to all faying surfaces of the fuel cell plug prior to forming the fuel seal boundary; and, a spray sealant applied to the entire fuel seal boundary and fuel cell plug once the fuel seal boundary is formed.

In another embodiment of the invention, there is provided a method for sealing a fuel tank, the method comprising the steps of: applying an adhesive sealant to all faying surfaces of a direct manufactured fuel cell plug; positioning the sealant applied plug into an area to be sealed in the fuel tank; and, spraying the entire sealed area with a spray sealant.

### BRIEF DESCRIPTION OF THE DRAWINGS

The foregoing and other advantages and features, and the manner in which the same are accomplished, will become readily apparent upon consideration of the following detailed description taken in conjunction with the accompanying drawings which illustrate preferred and exemplary embodiments, but which are not necessarily drawn to scale, wherein:

FIG. 1 is a perspective view of a commercial airplane showing shaded areas of fuel bays that employ the direct manufactured fuel cell plug and method of the invention;

FIG. 2 is a perspective view of a military airplane showing shaded areas of fuel bays that employ the direct manufactured fuel cell plug and method of the invention;

FIG. 3 is a perspective exploded view of a portion of a prior art fuel seal boundary in a fuel bay of an aircraft;

FIG. 4 is a perspective exploded view of a gap in a portion of a prior art fuel seal boundary in a fuel bay of an aircraft;

FIG. 5 is a perspective exploded view of a sheet metal dam in a portion of a prior art fuel seal boundary in a fuel bay of an aircraft;

FIG. 6 is a perspective exploded view of a sealant material applied to a sheet metal dam in a portion of a prior art fuel seal boundary in a fuel bay of an aircraft;

FIG. 7 is a perspective front view of an embodiment of the direct manufactured fuel cell plug with sealant material of the invention;

FIG. 8 is a perspective back view of an embodiment of the direct manufactured fuel cell plug of the invention;

FIG. 9 is a perspective exploded view of the direct manufactured fuel cell plug of the invention with an adhesive sealant material positioned in a portion of a fuel bay of an aircraft; and,

FIG. 10 is a perspective exploded view of the direct manufactured fuel cell plug of FIG. 9 positioned in a portion of a fuel bay of an aircraft and having a spray sealant coating.

### DETAILED DESCRIPTION OF THE INVENTION

Embodiments of the invention will now be described more fully hereinafter with reference to the accompanying drawings, in which some, but not all embodiments of the invention are shown. Indeed, several different embodiments may be provided and should not be construed as limited to the embodiments set forth herein. Rather, these embodiments are provided so that this disclosure will be thorough and complete and will fully convey the scope of the invention to those skilled in the art.

The fuel cell plug and method of sealing of the invention may be used with fuel seal boundaries for fuel tanks and fuel bays of aircraft, boats, and other large movable structures that use fuel to operate. Accordingly, one of ordinary skill in the art will recognize and appreciate that the inventive fuel cell plug and method of sealing can be used in any number of applications involving fuel seal boundaries for fuel tanks and fuel bays of aircraft, boats, and other large movable structures that use fuel to operate. As an example, but not in a limiting manner, the invention will be introduced, defined and explained with reference to aircraft, including commercial and military airplanes, and to any fuel tank incorporated into the structure of said aircraft.

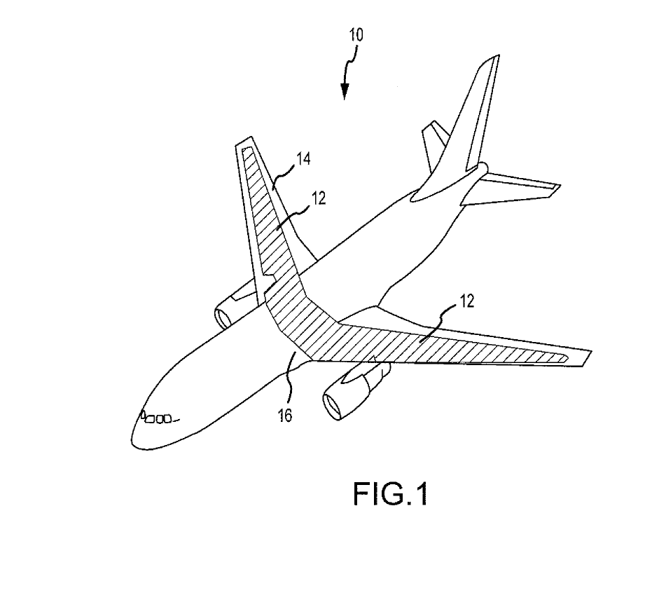

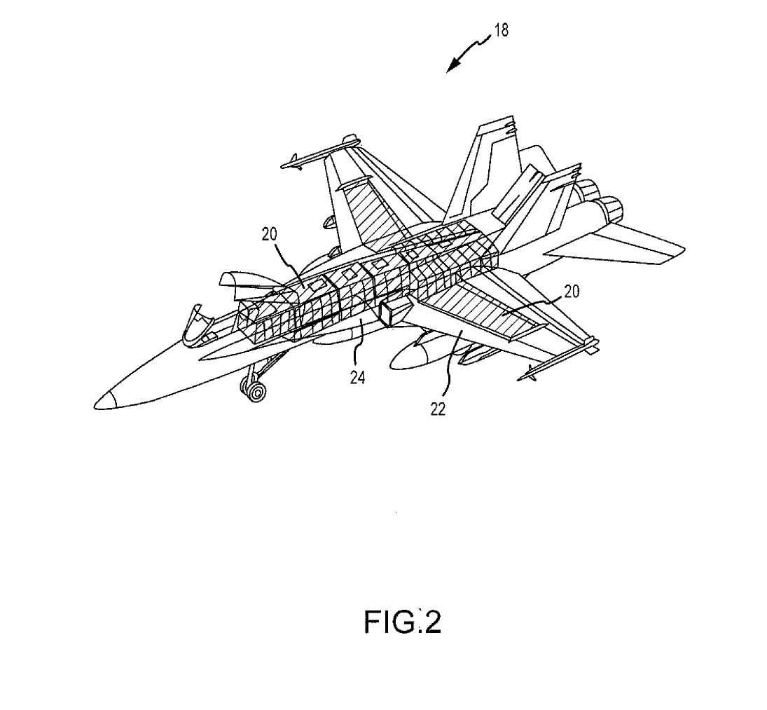

Referring now to the drawings, FIG. 1 is a perspective view of a commercial airplane 10 showing shaded areas of fuel bays or tanks 12 in wing sections 14 and fuselage sections 16 of the airplane that employ the direct manufactured fuel cell plug and method of the invention. FIG. 2 is a perspective view of a military airplane 18 showing shaded areas of fuel bays or tanks 20 in wing sections 22 and fuselage sections 24 of the airplane that employ the direct manufactured fuel cell plug and method of the invention.

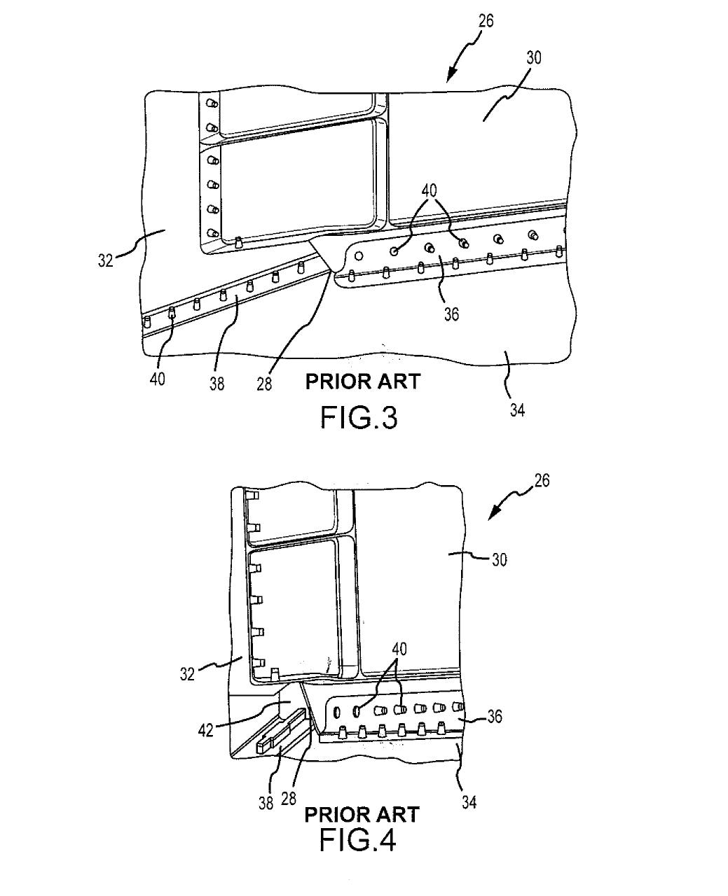

FIG. 3 is a perspective exploded view of a portion of a prior art fuel bay or tank 26 in a wing section of an aircraft having a fuel seal boundary 28. The fuel bay or tank 26 in the wing section typically comprises a spar portion 30, a rib portion 32, a skin portion 34, a first shear tie portion 36, a second shear tie portion 38, and fasteners 40. In an aircraft, the spar is the main structural member of the wing, running lengthways across the span of the wing, at approximate right angles to the fuselage. The spar is typically designed to either carry all the forces or the majority of the forces of both lift and the weight of the wings on the ground. Other structural and forming members, such as the ribs and shear ties, are typically attached to the spar or spars. The purpose of the spar is to provide strength to the wing and work in conjunction with the wing ribs and skin to provide strength.

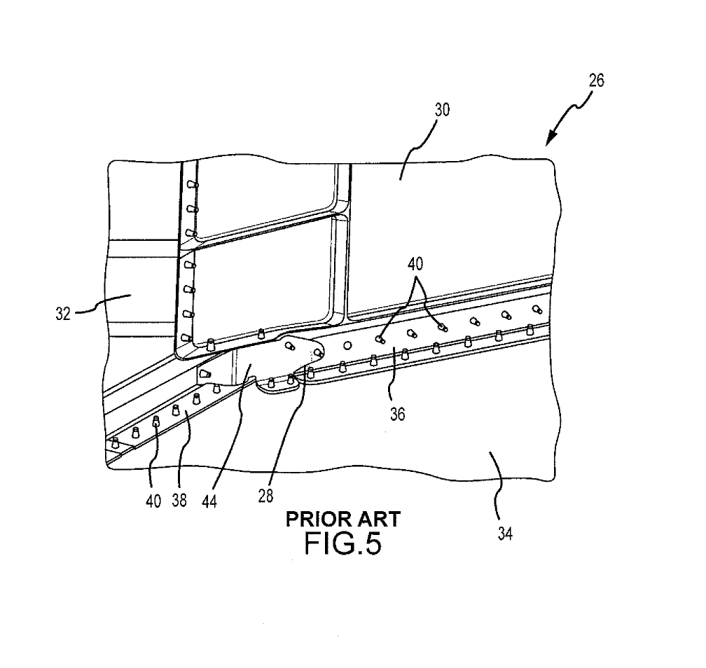

FIG. 4 is a perspective exploded view of a gap 42 in a portion of a prior art fuel bay or tank 26 in a wing section of an aircraft having fuel seal boundary 28. The fuel bay or tank 26 in the wing section comprises the spar portion 30, the rib portion 32, the skin portion 34, the first shear tie portion 36, the second shear tie portion 38, and fasteners 40. Prior art structural arrangements as designed can leave a large gap (e.g., 2 inch by 1.5 inch) in the fuel seal boundary which must be plugged. Per aircraft process specifications all gaps larger than a ¼ inch must be filled with a substantial plug or dam.

FIG. 5 is a perspective exploded view of a sheet metal dam 44 in a portion of a prior art fuel bay or tank 26 in a wing section of an aircraft having fuel seal boundary 28. The fuel bay or tank 26 in the wing section comprises the spar portion 30, the rib portion 32, the skin portion 34, the first shear tie portion 36, the second shear tie portion 38, and fasteners 40. The sheet metal dam 44 is positioned in and around the fuel seal boundary 28 in an attempt to close the gap formed in the fuel seal boundary. Known devices and methods for positioning and installing the sheet metal dam 44 (FIG. 5) include applying sealant between the sheet metal dam and all the mating surfaces (fay seal), wet installing fasteners 40 through the spar portion 30, the rib portion 32, the skin portion 34, the first shear tie portion 36, and the second shear tie portion 38. Wet installation means the fasteners are coated with a sealant material prior to installation. Additional sealant material is applied to all gaps between the metal dam 44 and the fuel seal boundary 28.

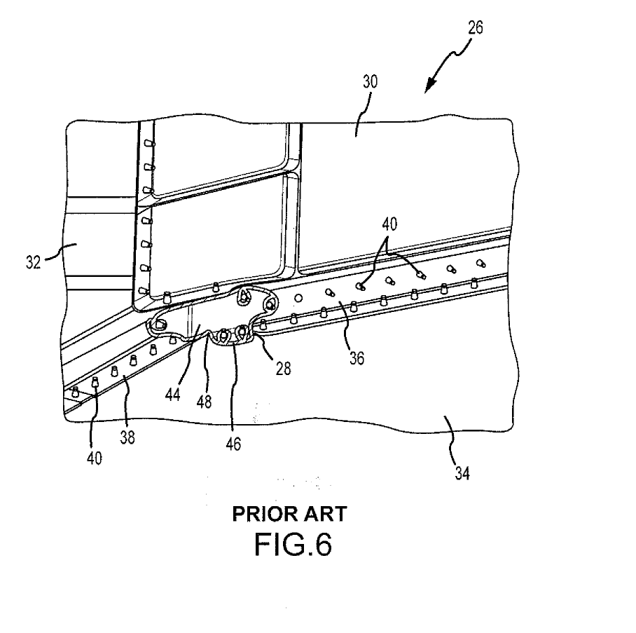

FIG. 6 is a perspective exploded view of a sealant material applied to the sheet metal dam 44 in a portion of a prior art fuel seal boundary 28 in a fuel bay or tank 26 of an aircraft located in the wing section of an aircraft comprising the spar portion 30, the rib portion 32, the skin portion 34, the first shear tie portion 36, the second shear tie portion 38, and fasteners 40. The adhesive sealant is generously applied to all gaps between the metal dam and the fuel seal boundary. If the gaps are over a certain size, dry fiberglass cloth (not shown), if required or used, may be applied over the adhesive sealant on a pressure side 48 of the metal dam 44 to bridge the gaps and secure the sealant in place by giving it structure. The fiberglass cloth prevents the adhesive sealant from leaking out of the sealed gap areas. Additional adhesive sealant can be applied to a surface of the fiberglass to secure the fiberglass in place and completely encapsulate the fiberglass within the sealant. Finally, additional adhesive spray sealant (not shown) can be fillet sealed (sealing against adjacent parts) around the entire periphery of the metal dam, fuel seal boundary, and adjacent structural parts.

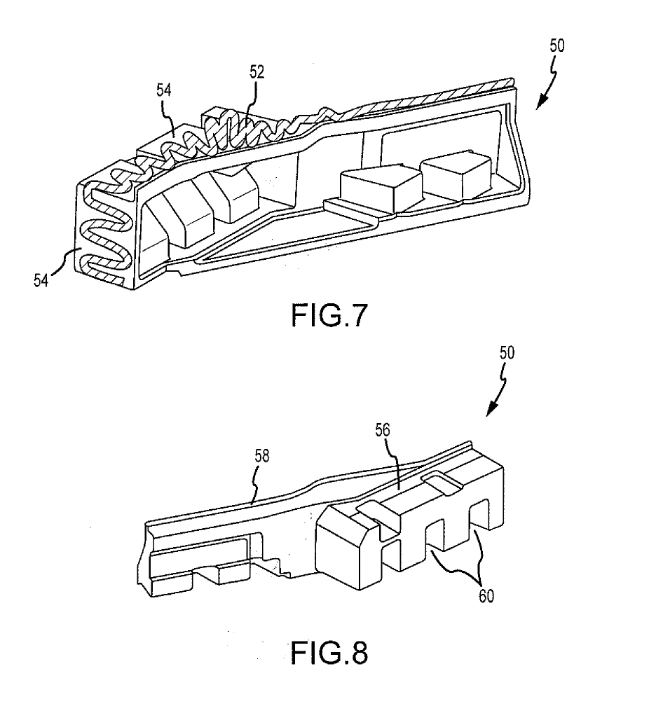

FIG. 7 is a perspective front view of an embodiment of a direct manufactured fuel cell plug 50 according to the invention. Preferably, the direct manufactured fuel cell plug comprises a digitally manufactured part that is preferably created on a computer as a three-dimensional computer aided design (CAD) model and then directly converted to a physically formed fuel cell plug. Preferably, any suitable CAD model may be used. The fuel cell plug is designed to securely fit into and seal an opening or gap to be sealed in a fuel bay or tank, preferably an aircraft fuel bay or tank, to eliminate all substantial gapping between the fuel cell plug and the opening. Preferably, the fuel cell plug is a unitary structure comprised of a material such as plastic, nylon, polycarbonate, acrylonitrile butadiene styrene (ABS), thermoplastic, acrylic, polyethylene, polypropylene, polyamide, polystyrene, polymethylmethacrylate, polyester, or polyolefins. However, the fuel cell plug may also be made of various metals or other suitable materials. As shown in FIG. 7, a sealant material 52 is preferably applied to faying or exposed surfaces 54 of the fuel cell plug immediately or shortly prior to securely fitting and sealing the fuel cell plug into the opening or gap. For purposes of this application, “faying surfaces” means the surface of a material that is in contact with another material to which it is joined. Preferably, the sealant material comprises polysulfone adhesive fuel sealant or another suitable sealant material.

FIG. 8 is a perspective back view of the direct manufactured fuel cell plug 50 of the invention. The fuel cell plug 50 may comprise at least one angled portion or draft 56 to compress the sealant material and prevent the sealant material from being wiped off the plug when the plug is fit into the opening of the fuel seal boundary of the fuel tank or bay. The fuel cell plug 50 may further comprise a lip portion or ridge 58 to secure, index, and more intimately seal or facilitate sealing of the fuel seal boundary gap. The lip portion or ridge 58 helps to capture the fuel cell plug on the opening of the fuel seal boundary of the fuel tank or bay so that it cannot move once it is installed. The fuel cell plug 50 may further comprise one or more pocket elements 60 designed to receive and fit around one or more existing fasteners 40 or fastener elements positioned on the fuel tank and adjacent structures. In addition, the pocket elements 60 may be designed to receive and fit around the surrounding structure. The pocket elements 60 are designed to provide clearance for the fasteners and facilitate installation of the fuel cell plug on the opening of the fuel seal boundary of the fuel tank or bay.

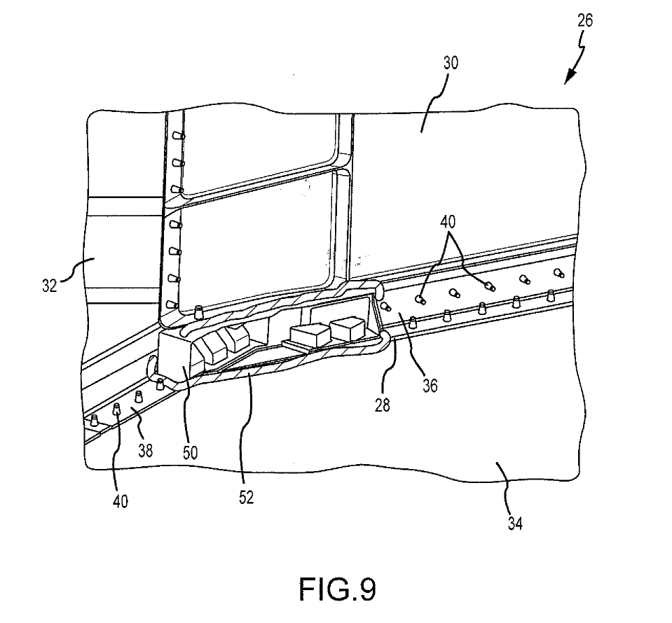

FIG. 9 is a perspective exploded view of the direct manufactured fuel cell plug 50 of the invention with sealant material 52 positioned in the fuel bay or tank 26 in a wing section of an aircraft having a fuel seal boundary 28. The fuel bay or tank 26 in the wing section comprises the spar portion 30, the rib portion 32, the skin portion 34, the first shear tie portion 36, the second shear tie portion 38, and fasteners 40.

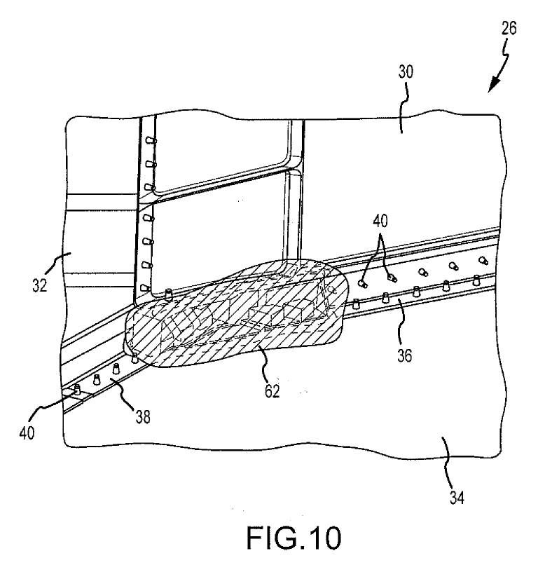

FIG. 10 is a perspective exploded view of the direct manufactured fuel cell plug 50 of FIG. 9 positioned in the fuel bay or tank 26 of an aircraft and having a portion of an additional spray sealant coating 62 shown applied over the fuel cell plug and boundaries, once the plug is inserted and sealed on the fuel seal boundary of the fuel bay or tank. Preferably, the spray sealant is fillet sealed around the entire periphery of the fuel cell plug, the fuel seal boundary, and adjacent structural parts. With a composite structure or part, preferably the spray sealant is sprayed over the sealed portion, the fuel seal boundary, and the entire part, including walls of the spars and ribs, fasteners, and faces of the skin. Preferably, the spray sealant is applied with a spray gun over the entire sealed area and fuel seal boundary area immediately after or shortly after the sealant applied plug is installed in the opening or gap of the fuel seal boundary. Preferably, the spray sealant is similar to the adhesive sealant material but is thinned with an appropriate solvent. Preferably, a thinned polysulfone adhesive fuel sealant suitable for spraying is used. However, other suitable spray sealants may also be used.

In another embodiment of the invention, there is provided a system for forming a fuel seal boundary in an aircraft fuel bay or tank comprising a digitally manufactured part created on a computer as a three-dimensional computer aided design (CAD) model and converted into a physical finished part comprising a direct manufactured fuel cell plug designed to form the fuel seal boundary and eliminate all substantial gapping between the fuel cell plug and the aircraft fuel bay. The system further comprises an adhesive sealant applied to all faying surfaces of the fuel cell plug prior to forming the fuel seal boundary. The system further comprises a spray sealant preferably applied to the entire fuel seal boundary and plug once the fuel seal boundary is formed. Preferably, the fuel cell plug is a unitary structure comprised of a material such as plastic, nylon, polycarbonate, acrylonitrile butadiene styrene (ABS), thermoplastic, acrylic, polyethylene, polypropylene, polyamide, polystyrene, polymethylmethacrylate, polyester, or polyolefins. However, the fuel cell plug may also be made of various metals or other suitable materials. Preferably, the sealant material comprises polysulfone adhesive fuel sealant, a thinned polysulfone adhesive fuel sealant suitable for spraying, or another suitable sealant material. The substantial gapping between the fuel cell plug and the aircraft fuel bay is a gap greater than ¼ inch in size. It should be noted that the particulars relating to the embodiment of the invention, as described above and in relation to FIGS. 7-10, apply with equal force to the particulars of this embodiment of the invention.

In another embodiment of the invention, there is provided a method for sealing a fuel tank or fuel bay, preferably an aircraft fuel tank or fuel bay. The method comprises the step of applying an adhesive sealant to all faying surfaces of a direct manufactured fuel cell plug. The method further comprises the step of positioning the sealant applied fuel cell plug into an area to be sealed in the fuel tank or bay. The fuel cell plug is designed to securely fit into and seal an opening or gap in the area to be sealed in a fuel tank or bay in order to eliminate all substantial gapping between the plug and the opening or gap. The method further comprises the step of spraying the entire sealed area with a spray sealant. Preferably, the direct manufactured fuel cell plug is a unitary structure comprised of a material such as plastic, nylon, polycarbonate, acrylonitrile butadiene styrene (ABS), thermoplastic, acrylic, polyethylene, polypropylene, polyamide, polystyrene, polymethylmethacrylate, polyester, or polyolefins. However, the fuel cell plug may also be made of various metals or other suitable materials. Preferably, the sealant material comprises polysulfone adhesive fuel sealant, a thinned polysulfone adhesive fuel sealant suitable for spraying, or another suitable sealant material. The method may further comprise the step, prior to the applying the adhesive sealant step, of creating the direct manufactured fuel cell plug on a computer as a three-dimensional digital computer aided design (CAD) model. Preferably, the direct manufactured fuel cell plug comprises a digitally manufactured part that is preferably created on a computer as a three-dimensional CAD model and then directly converted to a physically formed fuel cell plug. Preferably, any suitable CAD model may be used. It should be noted that the particulars relating to the embodiment of the invention, as described above and in relation to FIGS. 7-10, apply with equal force to the particulars of this embodiment of the invention.

The fuel cell plug and method of the invention provide a design-liberating, time-saving and machine tool-less device and method for sealing large gaps greater than ¼ inch in fuel seal boundaries in fuel tanks and fuel bays of aircraft, boats, and other large movable structures that use fuel to operate. The invention utilizes a direct manufactured fuel cell plug and known aircraft sealants to form a novel fuel seal boundary in fuel tanks and fuel bays. The method produces a fuel cell plug that has an intricate geometry that is completely and intimately adjacent to the surrounding aircraft structure. The plug and method of the invention do not require fasteners to secure gap-filling pressurized plugs to the nearby structure. Moreover, the method and plug of the invention do not require the use of fiberglass sheets to be applied over the adhesive sealant and do not require curing time for the sealant.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A direct manufactured fuel cell plug comprising a digitally manufactured part, wherein the fuel cell plug is designed to securely fit into and seal an opening to be sealed in a fuel tank to eliminate all substantial gapping between the fuel cell plug and the opening, and further wherein a sealant material is applied to the fuel cell plug prior to securely fitting and sealing the fuel cell plug into the opening.

2. The fuel cell plug of claim 1, wherein the fuel cell plug is a unitary structure comprised of a material selected from the group consisting of plastic, nylon, polycarbonate, acrylonitrile butadiene styrene (ABS), thermoplastic, acrylic, polyethylene, polypropylene, polyamide, polystyrene, polymethylmethacrylate, polyester, polyolefins, and metals.

3. The fuel cell plug of claim 1, wherein the fuel cell plug has faying surfaces to which the sealant material is applied.

4. The fuel cell plug of claim 1, wherein the fuel cell plug comprises at least one angled portion to compress the sealant material and prevent the sealant material from being wiped off the fuel cell plug when the fuel cell plug is fit into the opening.

5. The fuel cell plug of claim 1, wherein the fuel cell plug comprises a lip portion to secure, index, and facilitate sealing of a fuel seal boundary gap.

6. The fuel cell plug of claim 1, wherein the fuel cell plug comprises one or more pocket elements designed to receive and fit around one or more existing fastener elements positioned on the fuel tank.

7. The fuel cell plug of claim 1, wherein the sealant material is a polysulfone adhesive fuel sealant.

8. The fuel cell plug of claim 1, wherein the fuel cell plug is created on a computer as a three-dimensional computer aided design (CAD) model.

9. The fuel cell plug of claim 1, wherein the fuel tank is an aircraft fuel tank.

10. A system for forming a fuel seal boundary in an aircraft fuel bay comprising:
a digitally manufactured part created on a computer as a three-dimensional computer aided design (CAD) model and converted into a physical finished part comprising a direct manufactured fuel cell plug designed to form the fuel seal boundary and eliminate all substantial gapping between the fuel cell plug and the aircraft fuel bay;
an adhesive sealant applied to all faying surfaces of the fuel cell plug prior to forming the fuel seal boundary; and,
a spray sealant applied to the entire fuel seal boundary and fuel cell plug once the fuel seal boundary is formed.

11. The system of claim 10, wherein the fuel cell plug is a unitary structure comprised of a material selected from the group consisting of plastic, nylon, polycarbonate, acrylonitrile butadiene styrene (ABS), thermoplastic, acrylic, polyethylene, polypropylene, polyamide, polystyrene, polymethylmethacrylate, polyester, polyolefins, and metals.

12. The system of claim 10, wherein the sealant material is a polysulfone adhesive fuel sealant.

13. The system of claim 10, wherein the spray sealant comprises a thinned polysulfone fuel sealant suitable for spraying.

14. The system of claim 10, wherein the substantial gapping between the fuel cell plug and the aircraft fuel bay is a gap greater than ¼ inch in size.

15. A method for sealing a fuel tank, the method comprising the steps of:
applying an adhesive sealant to all faying surfaces of a direct manufactured fuel cell plug;
positioning the sealant applied plug into an area to be sealed in the fuel tank; and,
spraying the entire sealed area with a spray sealant.

16. The method of claim 15, wherein the direct manufactured fuel cell plug is a unitary structure comprised of a material selected from the group consisting of plastic, nylon, polycarbonate, acrylonitrile butadiene styrene (ABS), thermoplastic, acrylic, polyethylene, polypropylene, polyamide, polystyrene, polymethylmethacrylate, polyester, polyolefins, and metals.

17. The method of claim 15, wherein the adhesive sealant is a polysulfone adhesive fuel sealant.

18. The method of claim 15, further comprising the step, prior to the applying the adhesive sealant step, of creating the direct manufactured fuel cell plug on a computer as a three-dimensional digital computer aided design (CAD) model.

19. The method of claim 15, wherein the fuel tank is an aircraft fuel tank.

20. The method of claim 15, wherein the spray sealant comprises a thinned polysulfone fuel sealant suitable for spraying.
